(19) United States
(12) Patent Application Publication
(10) Pub. No.: US 2005/0169208 A1
(43) Pub. Date: Aug. 4, 2005

(54) Communication channel selection

(75) Inventors: Inmaculada Carrion-Rodrigo, San Diego, CA (US); Miikka Poikselka, Espoo (FI); Tuija Hurtta, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION, Espoo (FI)

(21) Appl. No.: 10/520,675

(22) PCT Filed: Jul. 11, 2003
(86) PCT No.: PCT/IB03/03543

(30) Foreign Application Priority Data
Jul. 12, 2002 (GB) 0216278.2
Jan. 15, 2003 (GB) 0300917.2

(51) Int. Cl. H04Q 7/00

(52) U.S. Cl. 370/328

(57) ABSTRACT

There is disclosed a method of establishing a communication connection for traffic between a user equipment and a network, comprising: transmitting a communication connection request from the user equipment to a network clement, the request including an indication of a preferred receiving a least a part of said request at the network element; selecting at the network element a communication connection for the traffic; and communicating the selected communication connection to the user equipment.

### FIELD OF THE INVENTION

The present invention relates to configuration of PDP contexts between a user equipment and a network, and particularly to such configuration for signalling traffic. The invention is particularly concerned with the situation where more than one possible PDP context may be provided, and particularly but not exclusively where the PDP contexts include a dedicated signalling PDP context and a general purpose PDP context.

### BACKGROUND TO THE INVENTION

In third generation mobile communication systems such as 3GPP systems, PDP contexts establish communication sessions between user equipment (UE) and the gateway GPRS support node (GGSN) in the communication network. In 3GPP release 5 (R5), it is proposed that IP multimedia subsystem related signalling traffic may be carried between the UE and the network on one of two PDP contexts: a dedicated signalling PDP context or a general purpose PDP context.

In 3GPP R5, it is proposed that the UE indicates to the network the desired PDP context by setting a flag in the protocol configuration options (PCO) sent to the network. If this flag is set, it indicates a request for the dedicated signalling PDP context. If this flag is not set, it indicates a request for the general purpose PDP context.

The dedicated signalling PDP context requires support from the network, for example the network must check that only signalling traffic is carried on the dedicated signalling PDP context. The 3GPP R5 specification allows for the operator of a network to choose whether to support dedicated signalling PDP contexts. If dedicated signalling PDP contexts are not supported by the network operator, then the user equipment should use the general purpose PDP context for IP multimedia subsystem related signalling.

Thus if the UE requests a dedicated signalling PDP context, the network may not be able to support such, and consequently the request by the user equipment may not be facilitated.

In addition, the PDP request is communicated to the gateway GPRS support node (GGSN) of a network via a serving GPRS support node (SGSN). If the SGSN is a pre-R5 version, then it will not support the use of the signalling flag in the secondary PDP context activation request or in the PDP context modification request indicating a request for a dedicated signalling PDP context, and will not forward such flag or request to the GGSN.

Thus if the UE requests a dedicated signalling PDP context, the GGSN may not receive the request, and consequently the request by the user equipment may not be facilitated.

If a request for a dedicated signalling PDP context is accepted by the network, the operator of a network may wish to decide which traffic is allowed use of such PDP context. 3GPP R5 specifies that the traffic on the dedicated signalling PDP context has to be of the type SIP, DHCP, or DNS. However the operator of the network may also wish to provide for other types of traffic to be supported on the dedicated signalling PDP context. For example, the traffic on the dedicated signalling PDP context may be free of charge to the user, and the operator may allow other types of traffic to be free of charge.

Thus, if a dedicated signalling PDP context is accepted, the UE may not know all the types of traffic which the network allows to be transported on that PDP context.

The above problems associated with the transmission of a flag identifying a type of PDP context requested by the UE may apply to flags other than that indicating a dedicated signalling PDP context is required. In general, the problem relates to any instance where the UE requests a particular type of PDP context, and for example the network cannot recognise or interpret the specific request, but just identifies a general request.

It is an object of the present invention to provide a solution to one or all of the above-stated problems.

### SUMMARY OF THE INVENTION

In accordance with the present invention there is provided a method of establishing a communication connection for traffic between a user equipment and a network, comprising: transmitting a communication connection request from the user equipment to a network element, the request including an indication of a preferred communication connection; receiving a least a part of said request at the network element; selecting at the network element a communication connection for the traffic; and communicating the selected communication connection to the user equipment. The communication connection is preferably a PDP context.

The step of communicating may comprise transmitting a message to the user equipment identifying the selected PDP context. The step of communicating may comprise transmitting a message to the user equipment identifying the non-selected PDP context. The step of selecting the PDP context may be dependent upon the preferred PDP context and the PDP contexts supported by the network.

The step of communicating may comprise transmitting a message to the user equipment confirming that the preferred PDP context is selected. The step of communicating may comprise transmitting a message to the user equipment rejecting the preferred PDP context.

The message may identify an alternative to the preferred PDP context. The step of selecting may comprise determining the type of traffic to be transmitted on the PDP context. The step of selecting may comprise selecting a first PDP context for a first set of traffic type and selecting a second PDP context for a second set of traffic type.

The step of communicating may include communicating the allowed traffic types to the user equipment. The traffic may be signalling traffic. The at least two PDP contexts may include a dedicated signalling PDP context and a general purpose PDP context.

The method may further comprise the step of receiving the POP request from the user equipment at a further network element, and transmitting the PDP request from the further network element to the network element.

The network element may remove the preferred PDP context from the request such S that the request transmitted from the further network element to the network element does not include an indication of a preferred POP context.

The step of communicating may include transmitting a cause code or signalling flag. The present invention further provides a method of establishing a POP context for signalling traffic between a user equipment and a network, comprising: receiving a first POP request from the user equipment at a first network element, the POP request including an identity of a preferred POP context; receiving a second POP request from the first network element at a second network element, the second PDP request including at least part of the first POP request; selecting, at the second network element, a POP context for the signalling traffic,; and confirming the selected PDP context to the user equipment.

The second POP request preferably includes the identity of the preferred POP context, wherein the second network element selects the PDP context in dependence on the preferred POP context and the POP contexts supported by the network.

The second PDP request may not include the identity of the preferred POP context, wherein the second network element selects the POP context in dependence on PDP contexts supported by the network.

The selected PDP context may be a default PDP context.

The selected POP context may include one of a dedicated signalling POP context and a general purpose POP context.

The step of confirming may comprise transmitting a cause code to the user equipment.

The present invention further provides a computer program product for storing computer program code adapted to perform the method of any one of the appended method claims.

In a further aspect the present invention provides a network element for determining a communication connection for traffic between a user equipment and a network, comprising: means for receiving a communication connection request from the user equipment; means for selecting a communication channel for the traffic; and means for communicating the selected communication to the user equipment. The communication channel is preferably a PDP context.

The communication channel request may include an identity of a preferred communication channel. The means for communicating may be adapted to transmit a message to the user equipment identifying the selected PDP context. The means for communicating may be adapted to transmit a message to the user equipment identifying the non-selected PDP context.

The means for selecting one of at least two PDP contexts may be responsive to the PDP contexts supported by the network.

The PDP request may include an identity of a preferred PDP context, the means for selecting being further responsive to the preferred PDP context. The means for communicating may be adapted to transmit a message to the user equipment confirming that the preferred POP context is selected.

The means for selecting may comprise means for determining the type of traffic to be transmitted on the PDP context.

The means for selecting may comprise means for selecting a first POP context for a first set of signalling types and means for selecting a second PDP context for a second set of signalling types. The means for communicating may be adapted to communicate the allowed traffic types to the user equipment. The traffic is preferably signalling traffic.

The POP contexts may include a dedicated signalling POP context and a general purpose PDP context. The network element is preferably a gateway GPRS support node. The means for requesting is preferably connected to receive the POP request from a serving GPRS support node.

The invention further provides a network element for determining a POP context for traffic between a user equipment and a network, comprising: means for receiving a first POP request from the user equipment at a first network element, the first POP request including an identity of a preferred PDP context; means for receiving a second PDP request from the first network element at a second network element, the second POP request including at least part of the first PDP request; the second network element including means for selecting a POP context for the traffic; and means for confirming the selected PDP context to the user equipment.

The second POP request may include the identity of the preferred POP context, the means for selecting being dependent upon the preferred POP context and the PDP contexts supported by the network.

The second POP request may not include the identity of the preferred POP context, wherein the second network element selects the PDP context in dependence on POP contexts supported by the network.

The selected POP context may be a default POP context. The selected POP context may be one of a dedicated signalling POP context and a general purpose POP context. The first network element may be a SGSN and the second network element may be a GGSN. Te message may be a cause code to the user equipment.

In accordance with the present invention there is also provided a communication system including a serving GPRS support node for receiving a POP request from a user equipment, the PDP request including an identity of a preferred POP context; and a gateway GPRS support node for receiving a POP request from the serving GPRS support node, wherein the gateway GPRS support node is adapted to select a dedicated signalling POP context or a general purpose POP context for signalling traffic between the user equipment and the communication system in dependence upon the PDP contexts supported by the network and to confirm the selected PDP context to the user equipment.

The gateway GPRS preferably support node receives the PDP request from the serving GPRS node including the identity of preferred PDP context, the gateway GPRS support node being further adapted to select the signalling PDP context in further dependence on the identity of the preferred PDP context.

The method and apparatus of the invention may further provide for the identity of the session requested by the UE being an emergency session, and preferably for the UE to transmit a POP request message that includes an indication of a request for an emergency PDP context. The emergency PDP context may be allowed in dependence on policy information for a media session.

The invention further provides a cause code for a communication system in which a PDP context is to be established traffic between a user equipment and a network, the PDP context being established by: receiving a POP request from the user equipment at a network element; selecting a dedicated signalling PDP context or a general purpose PDP context for the traffic; and confirming the selected PDP context to the user equipment using the cause code.

The invention still further provides a cause code for a 3GPP R5 communication system which indicates a signalling POP context activated by a network to a user equipment.

### BRIEF DESCRIPTION OF THE DRAWINGS

The invention will now be described by way of reference to the accompanying figures, in which:

FIG. 1 illustrates the main elements of a 3GPP network for illustrating the present invention;

FIG. 2 illustrates a known PDP context activation;

FIGS. 3(a) to 3(d) illustrate communication of a PDP context activation in accordance with embodiments of the present invention; and

FIGS. 4(a) and 4(b) illustrated the establishment of an emergency PDP context in accordance with embodiments of the present invention.

### DESCRIPTION OF PREFERRED EMBODIMENTS

The invention is described herein by way of reference to particular examples. However the invention is not limited in its applicability to the described examples.

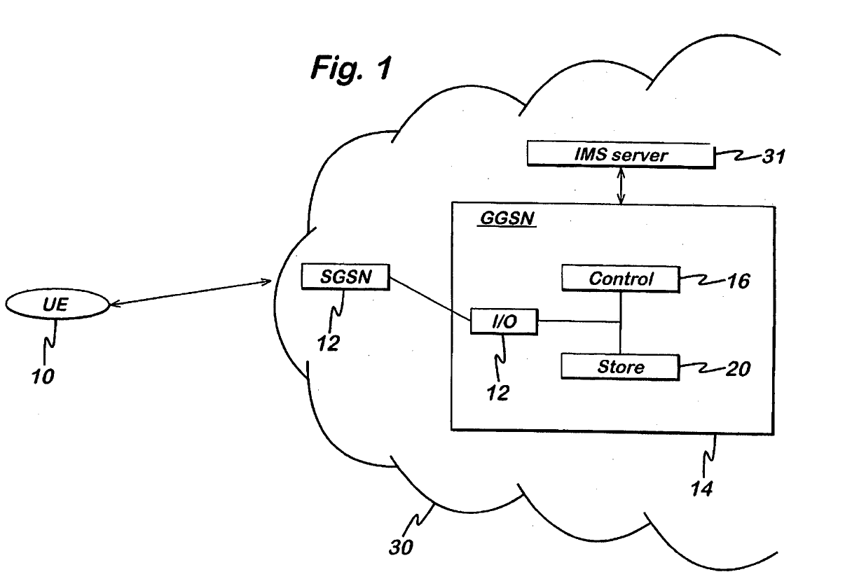

Referring to FIG. 1, there is illustrated the main elements of a 3GPP network for understanding a preferred embodiment of the present invention.

A user equipment (UE) 10 is connected in a communication network generally illustrated by reference numeral 30. The communication network 30 includes a serving GPRS support node (SGSN) 12 and a gateway GPRS support node (GGSN) 14. The configuration of the communication network 30 will be well-known to one skilled in the art. Generally, a communication session is established between the GGSN 14 of the communication network and the user equipment 10 via the SGSN 12.

In accordance with 3GPP R5, the communication network may support IP multimedia subsystem (IMS) related signalling traffic between the user equipment and the communication network on either a dedicated signalling packet data protocol (PDP) context or on a general purpose PDP context. This illustrated in FIG. 1 by an IMS server 31 connected in communications with the GGSN 14. The operator of the GGSN in the communication network will determine whether the dedicated signalling PDP context is supported by the communication network.

When the user equipment 10 initiates a session through the communication network, a PDP context must be established between the user equipment and the GGSN in the communication network. In accordance with 3GPP R5, the user equipment is able to request in establishing the PDP context that a dedicated signalling PDP context be used. This is done by setting a signalling flag at PDP context activation, at secondary PDP context activation, or at PDP context modification.

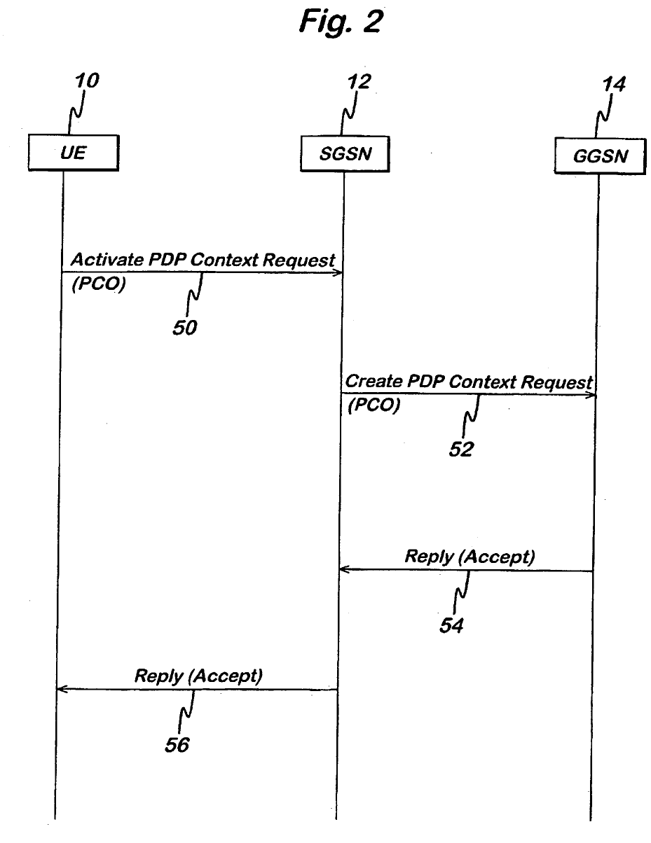

Referring to FIG. 2 in combination with FIG. 1, there is illustrated an example PDP context activation in accordance with a preferred embodiment of the present invention. The example shown is based on an “Activate PDP Context Request”.

Other examples include “Activate Secondary PDP Context Request” or “Modify PDP Context Request”.

In the PDP context activation, the UE 10 sends an Activate PDP Context Request message 50 to the SGSN 12 of the network 30. In accordance with 3GPP R5, this message may include protocol configuration options (PCO) possibly including the signalling flag. For the purposes of this example, it is assumed that the signalling flag is set, indicating a request for a dedicated signalling PDP context.

In accordance with known techniques, the SGSN 12 then transmits a Create POP Context Request message 52 to the GGSN 14. Again, this message may include a PCO possibly including the signalling flag.

The Create PDP Context Request message is received at an input/output block 18 of the GGSN 14. A control block 16 of the GGSN reads the message 52, and as part of the known procedure determines if the signalling flag is set. If the signalling flag is set, then the GGSN checks whether signalling PDP contexts are supported by the network. In this embodiment, the control block 16 checks a storage block 20 which stores details of the signalling PDP contexts supported by the network.

In the present example it is assumed that the network does support dedicated signalling PDP contexts. The control block 16 therefore configures a dedicated signalling POP context in accordance with known techniques.

In accordance with known techniques, once the PDP context is activated, the GGSN 14 transmits a Reply (Accept) message 54 back to the SGSN 12, which in turn transmits a Reply (Accept) message 56 to the UE 10.

In accordance with a preferred embodiment of the present invention, the Reply (Accept) messages are modified or extended to include an indication of the PDP context established. That is, the messages include an indication of whether the dedicated signalling POP context has been established. This can be done in a number of ways.

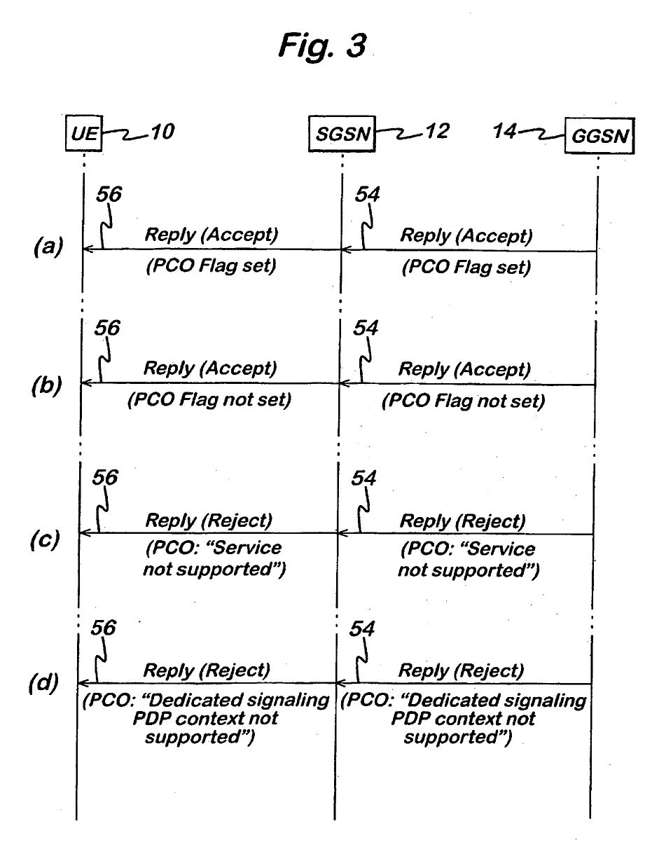

One embodiment for communicating the PDP context status to the UE is shown in FIG. 3(a), in which the Reply (Accept) messages include the protocol configuration options (PCO) including the signalling flag. The GGSN sets the signalling flag in the Reply (Accept) message 54 to indicate that the dedicated signalling PDP context has been established, and the SGSN copies the signalling flag to the Reply (Accept) message 56. In this way, the setting of the signalling flag in the Reply (Accept) message indicates to the UE whether the dedicated signalling PDP context has been established or whether the general purpose POP context has been established.

A further modification to the example described above is now considered, where the network does not support the dedicated signalling POP context. Two embodiments for such a scenario are considered below.

In a first embodiment, when the GGSN receives the Create POP Context Request with the signalling flag set, and the network does not support dedicated signalling PDP contexts, the network in any event establishes the POP context as a general purpose POP context. In this embodiment, there is no rejection of the PDP context, and hence there is no requirement for the UE to initiate a further PDP context activation, secondary PDP context activation, or PDP context modification. This has the advantage of requiring less signalling between the UE and the network. Preferably, the network informs the UE that the general purpose PDP context has been activated, and this may be done by not setting the signalling flag in the Reply (Accept) message 54 returned to the SGSN 12, and the Reply (Accept) message returned to the UE 10. This is illustrated in FIG. 3(b). As such, the UE knows the POP context established.

In a second embodiment, when the GGSN receives the Create PDP Context Request with the signalling flag set, and the network does not support dedicated signalling POP contexts, the POP context is rejected by the GGSN. In 3GPP R5 there is an existing cause code: “Service Not Supported”. This cause code could be returned to the UE. This is illustrated in FIG. 3(c). However, this does not give the UE information that it is the dedicated signalling PDP context that the network does not support. After receiving the PDP context rejection, the UE may need to initiate a POP context requesting the general purpose PDP context in order to proceed if such PDP context does not already exist.

For both the first and second embodiments described hereinabove, the present invention preferably further provides a new cause code for transmission to the UE. Such cause code may, for example, be: “Dedicated Signalling PDP Context not Supported”. Preferably this cause code is transported transparently through the SGSN, using the protocol configuration options (PCO). Alternatively the cause code may be carried from the GGSN to the SGSN, and from the SGSN to the UE, as is illustrated in FIG. 3(d).

In the above examples, it is assumed that all elements of the network support 3GPP R5. However, it is possible that pre-Release 5 3GPP SGSNs may be utilised in a network where the GGSN is R5. If the SGSN is pre-R5, it will not be able to recognise the signalling flag in the Activate Secondary PDP Context Request or Modify PDP Context Request. As such, the flag will not be forwarded to the GGSN and the GGSN will not know that the UE has requested a dedicated signalling PDP context. In such cases, the GGSN may allocate a general purpose PDP context, without realising that the UE was not expecting such.

Therefore in accordance with a preferred embodiment of the present invention, the GGSN always indicates a successful dedicated signalling PDP context activation, when the signalling flag is received and the network provides the required support. In this way, if the UE does not receive such indication, but does receive an indication that the PDP context has been activated, then it knows that the POP context activation is a normal one, i.e. a general purpose PDP context. Preferably the indication is provided transparently through the SGSN, for example in PCO. As discussed elsewhere herein, the indication may be sent using a new cause code, or by setting the signalling flag in the message to the UE.

In such a case, if the UE knows that the SGSN is pre-R5, then when it receives a message that the POP context was successfully activated it knows that this is a general purpose POP context. The UE may know that the SGSN is a pre-R5 SGSN if the Reply (Accept) message does not include the protocol configuration options. However in such case the dedicated signalling PDP context is not established on the basis that the SGSN is pre-R5, irrespective of whether the network supports dedicated signalling PDP contexts.

In a further embodiment, the present invention provides a mechanism for allowing the operator of the network to decide which traffic is allowed to be carried on an accepted signalling PDP context. The usefulness of this is that the operator may allow traffic on certain PDP contexts, such as the dedicated signalling PDP context to be carried free of charge. 3GPP R5 specifies that the dedicated signalling PDP context carries SIP, DHCP and DNS traffic. However the operator may also wish to allow other types of traffic to be transported on the dedicated signalling PDP context.

The invention therefore provides, in this embodiment, a means for notifying the UE of the type of traffic which may be supported on the selected PDP context. This information is preferably transported transparently through the SGSN, for example in the protocol configuration options (PCO) or in the traffic flow template (TFT). The network may send a list of allowed traffic, e.g. in the form of protocols, IP addresses, port numbers (from which protocols can be derived) and such like. The list of allowed traffic may be carried e.g. from the GGSN when sending the Reply (Accept) message.

As the present invention provides for communicating to the UE the PDP context activated, particularly where the UE requests a dedicated signalling PDP context, the user equipment is notified if in fact a general purpose PDP context is established, and the UE therefore knows that conventional charging may be applied to the PDP context. The UE is also preferably notified if additional traffic other than IP multimedia subsystem related signalling traffic may be carried on the PDP context.

The embodiments above describe the UE and network behaviour and information exchange at primary PDP context activation, i.e. when the UE sends Activate PDP Context Request to the network. The same UE and network behaviour and information exchange applies at secondary PDP context activation, i.e. when the UE sends Activate Secondary PDP Context Request to the network, or at POP context modification, i.e. when the UE sends Modify PDP Context Request to the network.

In the above examples there has been described an example scenario where a UE requests a particular type of PDP context by including a flag identifying that request in the PDP context request (either at PDP context activation, secondary PDP context activation, or optionally at PDP context modification. In the example scenario the request includes a signalling flag identifying that a dedicated PDP context is required.

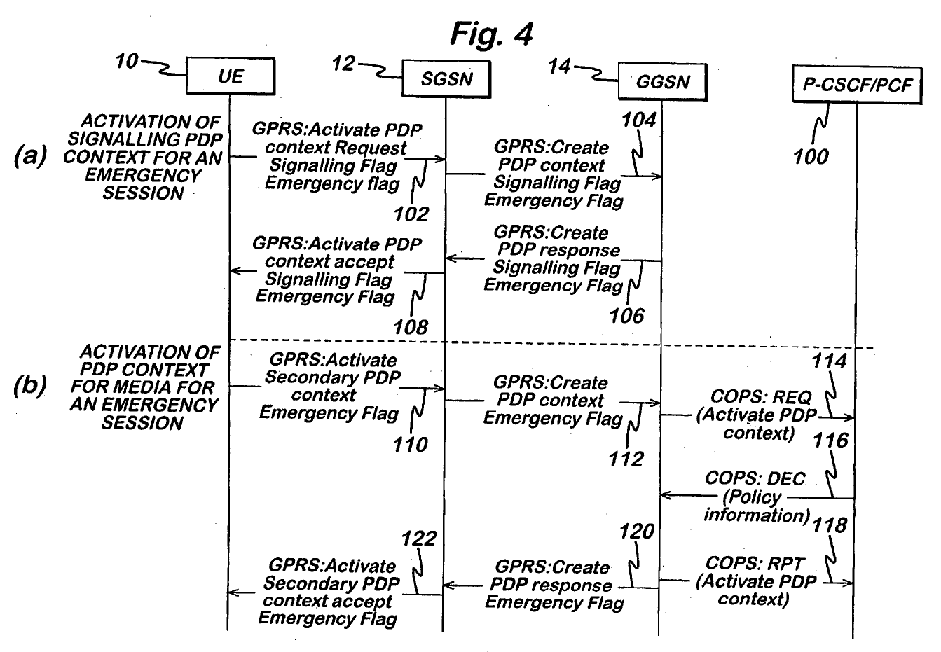

More generally, and as will be appreciated from the above description, the present invention facilitates the requesting of any specific PDP context by the UE, by means of a signalling flag identifying that context. A further example is given herein below with reference to FIG. 4, in which example the UE requests an establishment of an emergency session by including a signalling flag in the PDP context request identifying an emergency session indication—or emergency flag—in the request.

Such a flag may be needed since at GPRS level the mechanisms for establishing a bearer for an emergency session differ from the normal GPRS bearer establishment currently specified in 3GPP proposals. There is a need for the network to be able to detect the emergency session in order to be able to apply a special treatment to the associated bearers.

As discussed further in relation to the examples of FIG. 4, the UE establishes a bearer for an emergency session by including an emergency session indication—an emergency flag—during PDP context activation. This is applicable for both primary and secondary PDP context activation procedures. The indication is also needed in the attach request, if the UE has been detached before the emergency session and thus performs the attach first.

In accordance with this embodiment of the present invention, the user equipment is able to request in establishing a PDP context that an emergency session be established. This is done by setting a signalling flag at PDP context activation, at secondary PDP context activation, or optionally at PDP context modification.

Referring to FIG. 4(a) in combination with FIG. 1, there is illustrated an example PDP context activation for an emergency session in accordance with a preferred embodiment of the present invention. The example shown is based on an “Activate PDP Context Request”.

In the PDP context activation, the UE 10 sends an Activate POP Context Request message 102 to the SGSN 12 of the network 30, which message includes an emergency flag.

In accordance with known techniques, the SGSN 12 then transmits a Create PDP Context Request message 104 to the GGSN 14. Again, this message includes an emergency flag.

The Create PDP Context Request message is received at an input/output block 18 of the GGSN 14. A control block 16 of the GGSN reads the message 52, and identifies that the emergency flag is set. If the emergency flag is set, then the GGSN checks whether emergency signalling PDP contexts are available in the network for the UE 10. In an embodiment, the control block 16 may check the storage block 20 which may store details of the emergency signalling PDP contexts currently available in the network.

In the present example it is assumed that an emergency signalling POP context is available. The control block 16 therefore configures an emergency signalling PDP context in accordance with known techniques.

In accordance with known techniques, once the emergency PDP context is activated, the GGSN 14 transmits a Reply (Accept) message 106 back to the SGSN 12, which message includes an emergency flag. The SGSN 12 in turn transmits a Reply (Accept) message 108 to the UE 10, which message again includes an emergency flag.

As described above, in this embodiment of the present invention the Reply (Accept) messages are modified or extended to include an indication that the emergency POP context established. That is, the messages include an indication of whether the emergency signalling POP context has been established.

In this way it is positively confirmed to the UE that an emergency POP context has been established. If, for whatever reason, the network had been unable to establish the emergencyPDP context, then the absence of the emergency flag in the reply message to the UE would have informed that the UE that an emergency PDP context had not been established

Thus, in the case where the UE request an emergency PDP context, but the network only establishes a normal PDP context, the UE is made aware of such. This could happen, for example, in the scenario where the SGSN is not configured to interpret the emergency flag in the request, and therefore ignores it. In such a scenario, there is a need for the downlink communication to indicate that the specifically requested session has not been established.

A further option is that the UE receives a PDP context activation Reject message from the SGSN. This may happen, for example, if the emergency flag is understood by the SGSN (i.e. the flag is coded as “comprehension required’ in the protocol definition) and the SGSN is not configured to interpret the emergency flag. In this case, the rejection indicates to the UE that the SGSN is not able to allocate emergency PDP context to the UE.

The request for an emergency PDP context by the UE is a special case where it is important that the UE knows whether the specific context has been granted. The emergency PDP context cannot be dropped, may be allocated a higher priority than other contexts, and may be allocated special routing. Thus if the UE has been allocated a different type of context which does not have these expected features it is important that the UE knows it.

If the emergency PDP context is not established, the UE may take appropriate default action. This may comprise, for example, re-using for the IMS emergency session an already activated normal PDP context, or using the circuit-switched domain.

Referring to FIG. 4(b), there is shown a further example of the activation of a PDP context for media (and possibly signalling also) for an emergency session, for a secondary PDP context activation. In the secondary PDP context activation, the UE 10 sends an Activate Secondary PDP Context Request message 110 to the SGSN 12 of the network 30, which message includes an emergency flag indicated an emergency session.

If the signalling PDP context is dropped by the network for some reason, then the UE may reestablish the signalling PDP context for the emergency session by using a secondary PDP context. Using a secondary PDP context in this case ensures that the PDP context will be linked to the already existing PDP contexts for media for the emergency session.

In accordance with known techniques, the SGSN 12 then transmits a Create PDP Context Request message 112 to the GGSN 14. Again, this message includes an emergency flag.

The Create POP Context Request message is received at an input/output block 18 of the GGSN 14. A control block 16 of the GGSN reads the message 52, and identifies that the emergency flag is set. If the emergency flag is set, then the GGSN checks whether emergency signalling PDP contexts are available in the network for the UE 10. In an embodiment, the control block 16 may check the storage block 20 which may store details of the signalling PDP contexts currently available in the network. In the present example it is assumed that an emergency signalling PDP context is available. The control block 16 therefore configures an emergency signalling PDP context in accordance with known techniques.

In an optional embodiment, in determining whether the emergency session can be established that GGSN may transmits a COPS request message 114 to a proxy call state control function (P-CSCF) or policy decision function (PDF), referenced by numeral 100, which includes an identity of the PDP context requested. The P-CSCF/PCF 100 in such example stores information relating to network policy, and returns a COPS: decision message 116 to the GGSN, including details of the policy information. On the basis of this policy information the GGSN makes a decision as to whether the emergency PDP context can be supported, and sends a COPS report message 118 back to the P-CSCF/PCF 100 reporting its decision, which in the present case is to activate the emergency PDP context.

Thereafter, once the emergency PDP context is activated, the GGSN 14 transmits a Reply (Accept) message 120 back to the SGSN 12, which message includes an emergency flag. The SGSN 12 in turn transmits a Reply (Accept) message 122 to the UE 10, which message again includes an emergency flag.

Thus, as described hereinabove, in an embodiment the present invention allows for the transmission of an indication to the requestor as to whether a requested specific PDP context (PDP context for an emergency session) has been granted.

Whilst the present invention has been described herein by way of reference to particular embodiments, it is not limited to any such embodiments. The invention may be more broadly applied, as will be understood by one skilled in the art. The scope of protection is defined by the appended claims.

1-56. (canceled)

57. A method of establishing a communication connection for traffic between a user equipment and a network, comprising: transmitting a communication connection request from the user equipment to a network element, the request including an indication of a preferred communication connection; receiving at least a part of said request at the network element; selecting at the network element a communication connection for the traffic; and communicating the selected communication connection to the user equipment.

58. A method according to claim 57, wherein an alternative communication connection is selected at the network element in the event that the preferred communication connection is not supported by the network.

59. A method according to claim 57, wherein the communication connection is a PDP context.

60. A method according to claim 59, wherein the step of communicating comprises transmitting a message to the user equipment identifying the selected PDP context.

61. A method according to claim 59 wherein the step of communicating comprises transmitting a message to the user equipment identifying the non-selected PDP context.

62. A method according to claim 59, wherein the step of selecting the PDP context is dependent upon the preferred PDP context and the PDP contexts supported by the network.

63. A method according to claim 62 wherein the step of communicating comprises transmitting a message to the user equipment confirming that the preferred PDP context is selected.

64. A method according to claim 62 wherein the step of communicating comprises transmitting a message to the user equipment rejecting the preferred PDP context.

65. A method according to claim 62 wherein the message identifies an alternative to the preferred PDP context.

66. A method according to claim 59 wherein the step of selecting comprises determining the type of traffic to be transmitted on the PDP context.

67. A method according to claim 59, wherein the step of selecting comprises selecting a first PDP context for a first set of traffic type and selecting a second PDP context for a second set of traffic type.

68. A method according to claim 66 wherein the step of communicating includes communicating the allowed traffic types of the user equipment.

69. A method according to claim 59, wherein the traffic is signalling traffic.

70. A method according to claim 59 wherein the at least two PDP contexts include a dedicated signalling PDP context and a general purpose PDP context.

71. A method according to claim 59 further comprising the step of receiving the PDP request from the user equipment at a further network element, and transmitting the PDP request from the further network element to the network element.

72. A method according to claim 71, wherein the further network element removes the preferred PDP context from the request such that the request transmitted from the further network element to the network element does not include an indication of a preferred PDP context.

73. A method according to claim 59, wherein the step of communicating includes transmitting a cause code or signalling flag.

74. A method according to claim 57, wherein the communication request identifies an emergency connection request.

75. A method according to claim 74 wherein the communication request identifies an emergency PDP context.

76. A method according to claim 74, wherein the selection of the communication for the traffic is dependent upon a network policy.

77. A method of establishing a PDP context for signalling traffic between a user equipment and a network, comprising: receiving a first PDP request from the user equipment at a first network element, the PDP request including an identity of a preferred PDP context; receiving a second PDP request from the first network element at a second network element, the second PDP request including at least part of the first PDP request; selecting, at the second network element, a PDP context for the signalling traffic; and confirming the selected PDP context to the user equipment.

78. A method according to claim 77 wherein the second PDP request includes the identity of the preferred PDP context, wherein the second network element selects the PDP context in dependence on the preferred PDP context and the PDP contexts supported by the network.

79. A method according to claim 77, wherein the second PDP request does not include the identity of the preferred PDP context, wherein the second network element selects the PDP context in dependence on PDP contexts supported by the network.

80. A method according to claim 79, wherein the selected PDP context is a default PDP context.

81. A method according to claim 78 wherein the selected PDP context includes one of a dedicated signalling PDP context and a general purpose PDP context.

82. A method according to claim 78 wherein the step of confirming comprises transmitting a cause code to the user equipment.

83. A method according to claim 77 wherein the preferred PDP context is an emergency PDP context.

84. A computer program product for storing computer program code adapted to perform the method of claim 59.

85. A network element for determining a communication connection for traffic between a user equipment and a network, comprising: means for receiving a communication connection request from the user equipment; means for selecting a communication channel for the traffic; and means for communicating the selected communication to the user equipment.

86. A network element according to claim 85 wherein the communication channel is a PDP context.

87. A network element according to claim 85 wherein the communication channel request includes an identity of a preferred communication channel.

88. A network element according to claim 85 wherein the means for communicating is adapted to transmit a message to the user equipment identifying the selected PDP context.

89. A network element according to claim 85 wherein the means for communicating is adapted to transmit a message to the user equipment identifying the non-selected PDP context.

90. A network element according to claim 85 wherein the means for selecting one of at least two PDP contexts is responsive to the PDP contexts supported by the network.

91. A network element according to claim 90, wherein the PDP request includes an identity of a preferred PDP context, the means for selecting being further responsive to the preferred PDP context.

92. A network element according to claim 91 wherein the means for communicating is adapted to transmit a message to the user equipment confirming that the preferred PDP context is selected.

93. A network element according to claim 86 wherein the means for selecting comprises means for determining the type of traffic to be transmitted on the PDP context.

94. A network element according to claim 86 wherein the means for selecting comprises means for selecting a first PDP context for a first set of signalling types and means for selecting a second PDP context for a second set of signalling types.

95. A network element according to claim 93 wherein the means for communicating is adapted to communicate the allowed traffic types to the user equipment.

96. A network element according to claim 86 wherein the traffic is signalling traffic.

97. A network element according to claim 86 wherein the PDP contexts include a dedicated signalling PDP context and a general purpose PDP context.

98. A network element according to claim 86 comprising a gateway GPRS support node.

99. A network element according to claim 98 wherein the means for requesting is connected to receive the PDP request from a serving GPRS support node.

100. A network element according to claim 91 wherein the preferred communication channel is an emergency communication channel.

101. A network element for determining a PDP context for traffic between a user equipment and a network, comprising: means for receiving a first PDP request from the user equipment at a first network element, the first PDP request including an identity of a preferred PDP context; means for receiving a second PDP request from the first network element at a second network element, the second PDP request including at least part of the first PDP request; the second network element including means for selecting a PDP context for the traffic; and means for confirming the selected PDP context to the user equipment.

102. A network element according to claim 101 wherein the second PDP request includes the identity of the preferred PDP context, the means for selecting being dependent upon the preferred PDP context and the PDP contexts supported by the network.

103. A network element according to claim 102 wherein the second PDP request does not include the identity of the preferred PDP context, wherein the second network element selects the PDP context in dependence on PDP contexts supported by the network.

104. A network element according to claim 103 wherein the selected PDP context is a default PDP context.

105. A network element according to claim 101 wherein the selected PDP context is one of a dedicated signalling PDP context and a general purpose PDP context.

106. A network element according to claim 101 wherein the first network element is a SGSN and the second network element is a GGSN.

107. A network element according to claim 106 wherein the message is a cause code to the user equipment.

108. A network element according to claim 101 wherein the preferred PDP context is an emergency PDP context.

109. A communication system including a serving GPRS support node for receiving a PDP request from a user equipment, the PDP request including an identity of a preferred PDP context; and a gateway GPRS support node for receiving a PDP request from the serving GPRS support node, wherein the gateway GPRS support node is adapted to select a dedicated signalling PDP context or a general purpose PDP context for signalling traffic between the user equipment and the communication system in dependence upon the PDP contexts supported by the network and to confirm the selected PDP context to the user equipment.

110. A communication system according to claim 109 wherein the gateway GPRS support node receives the PDP request form the serving GPRS node including the identity of preferred PDP context, the gateway GPRS support node being further adapted to selected the signalling PDP context in further dependence on the identity of the preferred PDP context.

111. A cause code for a communication system in which a PDP context is to be established for traffic between a user equipment and a network, the PDP context being established by: receiving a PDP request from the user equipment at a network element; selecting a dedicated signalling PDP context or a general purpose PDP context for the traffic; and confirming the selected PDP context to the user equipment using the cause code.

112. A cause code for a 3GPP R5 communication system which indicates a signalling PDP context activated by a network to a user equipment.
